(19) United States
(12) Patent Application Publication
(10) Pub. No.: US 2015/0221037 A1
(43) Pub. Date: Aug. 6, 2015

(54) SYSTEM AND METHOD FOR ALLOCTING INVESTMENT FUND FOR AN APPLICATION

(71) Applicants: Sourav Sam Bhattacharya, Fountain Hills, AZ (US); Mohammad Asharaf, Bellevue, WA (US)

(72) Inventors: Sourav Sam Bhattacharya, Fountain Hills, AZ (US); Mohammad Asharaf, Bellevue, WA (US)

(73) Assignee: Wipro Limited, Bangalore (IN)

(21) Appl. No.: 14/173,436

(22) Filed: Feb. 5, 2014

(51) Int. Cl. G06Q 40/06

(52) U.S. Cl. CPC G06Q 40/06

(57) ABSTRACT

A method and system for optimizing investment fund allocation for an application is provided. The method may include identifying a directed graph representative of the application, the directed graph comprising a plurality of nodes and paths, where an incremental investment amount and an incremental revenue value are associated with the respective nodes and paths. The method may further include determining, using a computer processor, a path of the directed graph that provides a maximum return on investment among the plurality of paths of the directed graph. The method may further include allocating an investment amount, equaling the incremental investment amount associated with the path, to the path of the directed graph, and updating the incremental revenue value associated with the respective nodes and paths based on the incremental revenue value associated with the path of the directed graph.

### TECHNICAL FIELD

This disclosure relates generally to optimizing application design optimization and, more particularly, to systems and methods for allocating investment fund for an application to maximize revenue generation by the application.

### BACKGROUND

Advances in mobile technology platforms and Internet protocols have encouraged many organizations to move their transactions into the digital space. For example, retailers of all sizes are increasingly reliant on websites and digital applications to sell their products and/or services, negotiate pricing and support arrangements, receive and respond to customer feedback and requests, and collect data about usage patterns and trends. As a result, websites and digital applications have become an important gateway between transacting parties for purposes of electronic commerce.

Websites and digital applications may include a large number of related web pages in connection with advertisement and/or sales of goods or services. Individual web pages may be linked together using hyperlinks that allow a user to navigate to different pages within the web site to locate content of interest or perform transactions. Due to the large number of webpages and hyperlinks, it may be difficult for owners of the website and applications to estimate the amount of spending allocated to each web page and/or hyperlink to maximize revenue for the owner of the website, especially under the constraint of a limited investment fund.

### SUMMARY

According to an exemplary embodiment, a method for optimizing investment fund allocation for an application is provided. The method may include identifying a directed graph representative of the application, the directed graph comprising a plurality of nodes and paths, wherein an incremental investment amount and an incremental revenue value are associated with the respective nodes and paths; determining, using a computer processor, a path of the directed graph that provides a maximum return on investment among the plurality of paths of the directed graph; allocating an investment amount, equaling the incremental investment amount associated with the path, to the path of the directed graph; and updating the incremental revenue value associated with the respective nodes and paths based on the incremental revenue value associated with the path of the directed graph. The method may further include repeating the determining, allocating, and updating steps until no investment amount is available. Determining the path of the directed graph that provides the maximum return on investment may be based, at least in part, on a ratio of the incremental revenue value to the incremental investment amount associated with the respective nodes and paths. Determining the path of the directed graph that provides the maximum return on investment may include sorting, a plurality of paths associated with the respective nodes, according to the ratio of the incremental revenue value to the incremental investment amount for the plurality of paths associated with the respective nodes. The method may further include determining that remaining investment funds are insufficient to allocate to a particular path of the directed graph, determining that a user selects to maximize spending with best possible return on investment, and excluding the particular path as the path of the directed graph. In addition, updating the incremental revenue value associated with the respective nodes and paths may include determining that one or more of the respective nodes and paths share a common node with the path of the directed graph, and increasing, the incremental revenue value associated with the one or more of the respective nodes and path, by a first amount, based at least in part, on the incremental revenue value associated with the path of the directed graph. Updating the incremental revenue value associated with the respective nodes and paths may further include determining that the one or more of the respective nodes and paths share a common link with the path of the directed graph, and increasing, the incremental revenue value associated with the one or more respective nodes and path, by a second amount, based at least in part, on the incremental revenue value associated with the path of the directed graph. The application may be an e-commerce website.

According to another exemplary embodiment, a system for optimizing investment fund allocation for an application is provided. The system may include a one or more hardware processors and a memory storing instructions that, when executed by the one or more hardware processors, may cause the one or more hardware processors to perform operations including: identifying a directed graph representative of the application, the directed graph comprising a plurality of nodes and paths, wherein an incremental investment amount and an incremental revenue value are associated with the respective nodes and paths; determining a path of the directed graph that provides a maximum return on investment among the plurality of paths of the directed graph; allocating an investment amount, equaling the incremental investment amount associated with the path, to the path of the directed graph; and updating the incremental revenue value associated with the respective nodes and paths based on the incremental revenue value associated with the path of the directed graph.

According to another exemplary embodiment, a non-transitory computer-readable medium storing instructions for optimizing investment fund allocation for an application is provided. The non-transitory computer-readable medium, when executed by a processor, may cause the processor to perform operations including: identifying a directed graph representative of the application, the directed graph comprising a plurality of nodes and paths, wherein an incremental investment amount and an incremental revenue value are associated with the respective nodes and paths; determining a path of the directed graph that provides a maximum return on investment among the plurality of paths of the directed graph; allocating an investment amount, equaling the incremental investment amount associated with the path, to the path of the directed graph; and updating the incremental revenue value associated with the respective nodes and paths based on the incremental revenue value associated with the path of the directed graph.

Additional objects and advantages of the present disclosure will be set forth in part in the following detailed description, and in part will be obvious from the description, or may be learned by practice of the present disclosure. The objects and advantages of the present disclosure will be realized and attained by means of the elements and combinations particularly pointed out in the appended claims.

It is to be understood that the foregoing general description and the following detailed description are exemplary and explanatory only, and are not restrictive of the invention, as claimed.

### BRIEF DESCRIPTION OF THE DRAWINGS

The accompanying drawings, which constitute a part of this specification, illustrate several embodiments and, together with the description, serve to explain the disclosed principles.

FIG. 1 is a block diagram of an exemplary network system for implementing embodiments consistent with the present disclosure.

FIG. 2 illustrates a directed graph in connection with an e-commerce application.

FIG. 3 is an exemplary functional block diagram of a fund allocation system, according to some embodiments of the present disclosure.

FIG. 4 is a flowchart of an exemplary investment fund allocation process, consistent with some embodiments of the present disclosure.

FIG. 5 is a flowchart of an exemplary method for identifying a path for allocating investment funds, consistent with some embodiments of the present disclosure.

FIG. 6 is a flowchart of an exemplary method for allocating investment funds to a selected path, consistent with some embodiments of the present disclosure.

FIG. 7 illustrates an incremental attributes updating process, consistent with some embodiments of the present disclosure.

FIG. 8 is a flowchart of an exemplary method for updating attributes data, consistent with some embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. It is intended that the following detailed description be considered as exemplary only, with the true scope and spirit being indicated by the following claims.

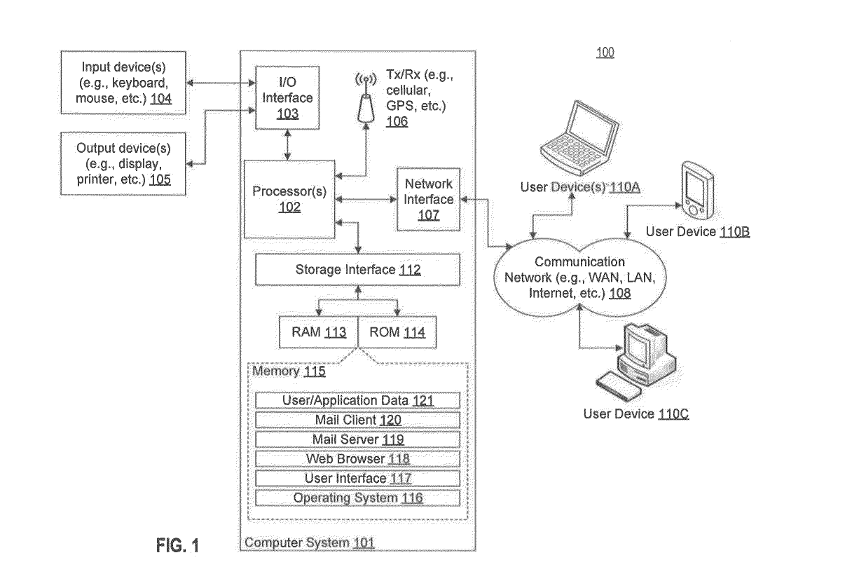

FIG. 1 is a block diagram of an exemplary network system 100 for implementing embodiments consistent with the present disclosure. Variations of computer system 101 may be used for implementing any of the systems, modules, components, or devices presented in this disclosure. Computer system 101 may comprise one or more central processing units (“CPU” or “processor”) 102. Processor 102 may comprise at least one data processor for executing program components for executing user- or system-generated requests. A user may include a person, a person using a device such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 102 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 102 may be disposed in communication with one or more input/output (I/O) devices via I/O interface 103. I/O interface 103 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.11 a/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using I/O interface 103, computer system 101 may communicate with one or more I/O devices. For example, input device 104 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 105 may be a printer, fax machine, video display (e.g., cathode ray tube (CRT), liquid crystal display (LCD), light-emitting diode (LED), plasma, or the like), audio speaker, etc. In some embodiments, a transceiver 106 may be disposed in connection with the processor 102. The transceiver may facilitate various types of wireless transmission or reception. For example, the transceiver may include an antenna operatively connected to a transceiver chip (e.g., Texas Instruments WiLink WL1283, Broadcom BCM47501UB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, processor 102 may be disposed in communication with a communication network 108 via a network interface 107. Network interface 107 may communicate with communication network 108. Network interface 107 may employ connection protocols including, without limitation, direct connect, Ethernet (e.g., twisted pair 10/100/1000 Base T), transmission control protocol/internet protocol (TCP/IP), token ring, IEEE 802.1 a/b/g/n/x, etc. Communication network 108 may include, without limitation, a direct interconnection, local area network (LAN), wide area network (WAN), wireless network (e.g., using Wireless Application Protocol), the Internet, etc. Using network interface 107 and communication network 108, computer system 101 may communicate with devices 110A-C (collectively “user devices 110”). These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, computer system 101 may itself embody one or more of these devices.

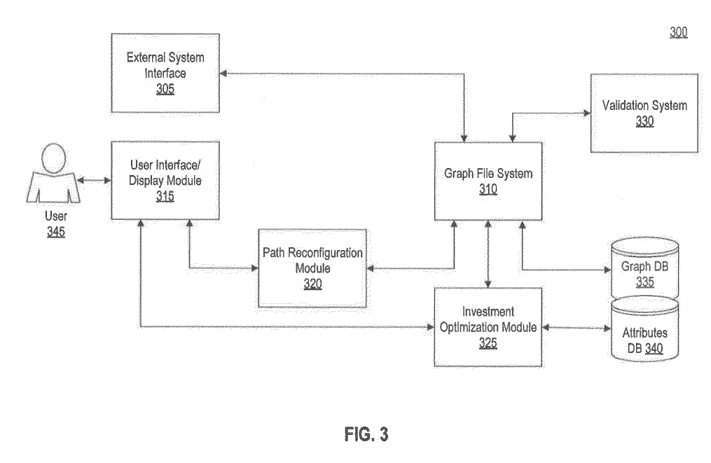

In some embodiments, processor 102 may be disposed in communication with one or more memory devices (e.g., RAM 113, ROM 114, etc.) via a storage interface 112. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc. Variations of memory devices may be used for implementing, for example, one or more modules, such as investment optimization module 325 and graph file system 310, as shown in FIG. 3.

The memory devices may store a collection of program or database components, including, without limitation, an operating system 116, user interface application 117, web browser 118, mail server 119, mail client 120, user/application data 121 (e.g., any data variables or data records discussed in this disclosure), etc. Operating system 116 may facilitate resource management and operation of computer system 101. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 117 may facilitate display, execution, interaction, manipulation, or operation of program components through textual or graphical facilities. For example, user interfaces may provide computer interaction interface elements on a display system operatively connected to computer system 101, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, computer system 101 may implement a web browser 118 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, computer system 101 may implement a mail server 119 stored program component. Mail server 119 may be an Internet mail server such as Microsoft Exchange, or the like. Mail server 119 may utilize facilities such as ASP, ActiveX, ANSI C++/C#, Microsoft .NET, CGI scripts, Java, JavaScript, PERL, PHP, Python, WebObjects, etc. Mail server 119 may utilize communication protocols such as internet message access protocol (IMAP), messaging application programming interface (MAPI), Microsoft Exchange, post office protocol (POP), simple mail transfer protocol (SMTP), or the like. In some embodiments, computer system 101 may implement a mail client 120 stored program component. Mail client 120 may be a mail viewing application, such as Apple Mail, Microsoft Entourage, Microsoft Outlook, Mozilla Thunderbird, etc.

In some embodiments, computer system 101 may store user/application data 121, such as the data, variables, records, etc. (e.g., record of transactions, response objects, response chunks) as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of any computer or database component may be combined, consolidated, or distributed in any working combination.

The specification has described systems and methods for allocating funds for an application. It should be understood that an application may include a website application, or any other internet or mobile application without departing from the scope of the present disclosure.

The illustrated components and steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

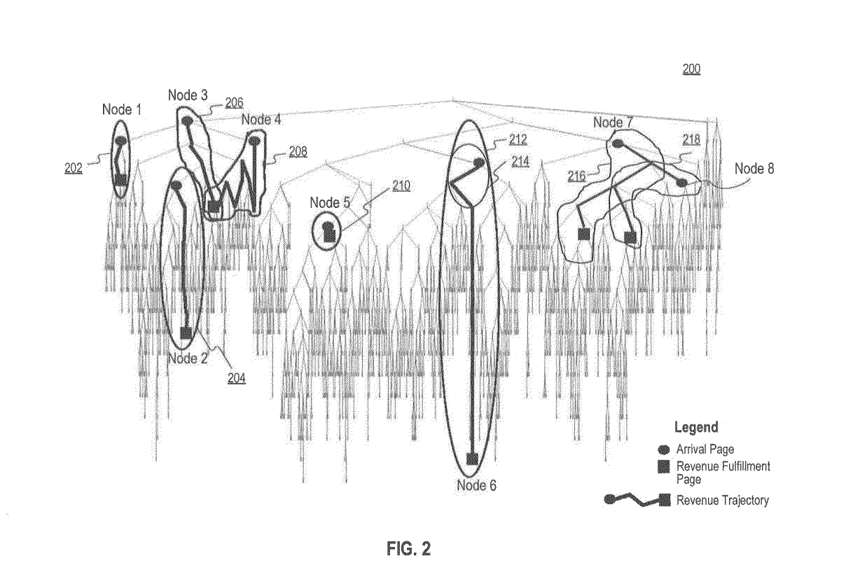

FIG. 2 illustrates a directed graph 200 in connection with an e-commerce application. Websites and applications may be described as elements of navigation tree services where the underlying functionalities, e.g., providing a webpage to a user, displaying an application view to a user, creating an account for a user, authenticating a user, confirming a purchase made by the user, etc., are modularized. For example, navigating through the pages of a website on interface screens of an application may be analogized to traversing the branches of a tree. Besides organizing and presenting these functionalities to a user in an intuitive and interactive fashion, navigation tree services may also seamlessly integrate local (client-side) resources (e.g., receiving input from the user, presenting information to a user, determining the user's location, etc.) and remote (server-side) resources (accessing the user's financial records, validating information with a third-party, recalling the user's preferences, etc.).

As illustrated in FIG. 2, a directed graph 200 comprises a plurality of nodes, for example, nodes 1-8, and paths (i.e., a set of connections between nodes), for example paths 202-218. In the context of websites and/or applications, a directed graph may be in the form of a navigation tree. In the case where the navigation tree service is a website or application, nodes of the directed graph based on the navigation tree service may correspond to pages in the website or views in the application. Connectivity between nodes may be defined based on the navigation options presented to the user in the corresponding page or view. For example, in a website, a connection from page X to page Y may be established if there is link on page X to page Y. Data from analytical tools may also be used to define connectivity. For example, web analytics may show that significant portion of the traffic on page Y originates from the link on page X, thus supporting a connection between the nodes corresponding to X and Y in the directed graph. In the case of a generic navigation tree service, nodes may correspond to the modules that encapsulate discrete parts of the navigation tree service, e.g., particular functionalities of the navigation tree service, and connectivity may be defined based on either links between the modules or observation of existing traffic patterns between the modules.

The nodes of the directed graph in connection with an application may include one or more revenue nodes corresponding to pages where customers make a confirmed purchase, such as nodes 2 and 6 in FIG. 2. The directed graph may include arrival nodes corresponding to arrival pages of a website or application, such as nodes 1, 3, and 4. The path from arrival node to the revenue node, for example paths 202-218, may be referred to as a revenue trajectory or path in the present disclosure. It should be understood that the directed graph may contain other paths in addition to the revenue trajectories.

An organization or business entity may make investments across one or more paths in the directed graph to improve revenue. For example, the organization may improve the design of a webpage, corresponding to a node of the directed graph, to attract more sales of the listed products. As another example, an organization may devote more advertising or marketing resources to that page. Consistent with some embodiments of the present disclosure, the computer system 101 may analyze attributes associated with the plurality of nodes and paths in the directed graph and determine a scheme to allocate the investment fund among the plurality of nodes and paths.

FIG. 3 is an exemplary functional block diagram of a fund allocation system 300, according to some embodiments of the present disclosure. With reference to FIG. 3, in some embodiments, fund allocation system 300 may include an external system interface 305, a graph file system 310, a user interface and/or display module 315, a path reconfiguration module 320, an investment optimization module 325, a validation system 330, a graph database 335, and an attributes database 340. As described above, fund allocation system 300 may be implemented by, for example, computer system 101.

Fund allocation system 300 may communicate with one or more external systems, such as a web analytics system, via external system interface 305. For example, external system interface 305 may receive inputs, such as revenue realized on a path, or provide outputs, such as investment fund allocation plan, to external systems. External system interface 305 can be a software program and/or a hardware device.

Fund allocation system 300 may communicate with one or more users, e.g., user 345, via user interface and/or display module 315. User 345 may provide input to fund allocation system 300 or view the output generated by fund allocation system 300 via user interface and/or display module 315. In some embodiments, user 345 may provide input, e.g., total amount of investment fund available, for investment fund allocation. In some embodiments, user 345 may select different modes for fund allocation via user interface and/or display module 315. For example, user 345 may select to maximize spending with best possible return on investment, or user 345 may select to maximize return on investment.

User interface and/or display module 315 may display a directed graph or navigation tree representative of an application to user 345. In some embodiments, user 345 may select to reconfigure paths of the navigation tree representative of an application via user interface and/or display module 315. User interface and/or display module 315 may then send the path reconfiguration request to path reconfiguration module 320 for processing. Path reconfiguration module 320 may reconfigure the navigation tree representative of an application to implement a hypothetical scenario (e.g., a WHAT-IF scenario) for testing or analysis. In some embodiments, path reconfiguration module 210 may also output a modified website/webpage or application that reflects the reconfigured navigation tree.

Graph file system 310 may receive inputs from other modules or systems of fund allocation system 300, and generate a directed graph or navigation tree for an application of interest. For example, graph file system 310 may interact with external system interface 305 or user interface and/or display module 315 to receive input information associated with an application, identify a directed graph representation of the application, and provide the graph representation to an external system or user. In some implementations, graph file system 310 may receive the graph representative an application from a user or external system directly.

Validation system 330 may validate the graph provided by graph file system 310 by checking whether there exist any inconsistencies (e.g., infinite cyclic loops and the like) in the graph. For example, validation system 330 may perform validation of a directed graph by ensuring that all nodes are connected and the specified attributes associated with the nodes and paths are consistent. Validation of a directed graph may be performed, for example, each time a directed graph is generated by graph file system 310. The graph provided by graph file system 310 and data structures associated with the graph may be stored in graph database 335.

Investment optimization module 325 may compute an optimized investment plan on investment fund allocation across multiple nodes and paths, based on the graph representation of the application provided by graph file system 310, in order to achieve the best return on investment. In computing the optimized investment plan, investment optimization module 325 may take into account of the user input, such as, the available investment amount, user preferences on how to spend the fund, etc. Investment optimization module 325 may also take into account of the attributes associated with the nodes and paths stored in attributes database 340, to compute the optimized investment plan. For example, investment optimization module 325 may use linear programming techniques for the optimization.

Attributes database 340 may store attributes associated with each path and/or node of the directed graph representative of an application. The attributes may include current spending level, current revenue earning, incremental investment amount, incremental revenue amount, or the like, for each path/or node in the directed graph. The attributes data may be provided by user 345 through user interface and/or display module 315, or by external systems via external system interface 305. In some embodiments, attributes database 340 may also store outputs generated by investment optimization module 325 when computing the optimized investment plan.

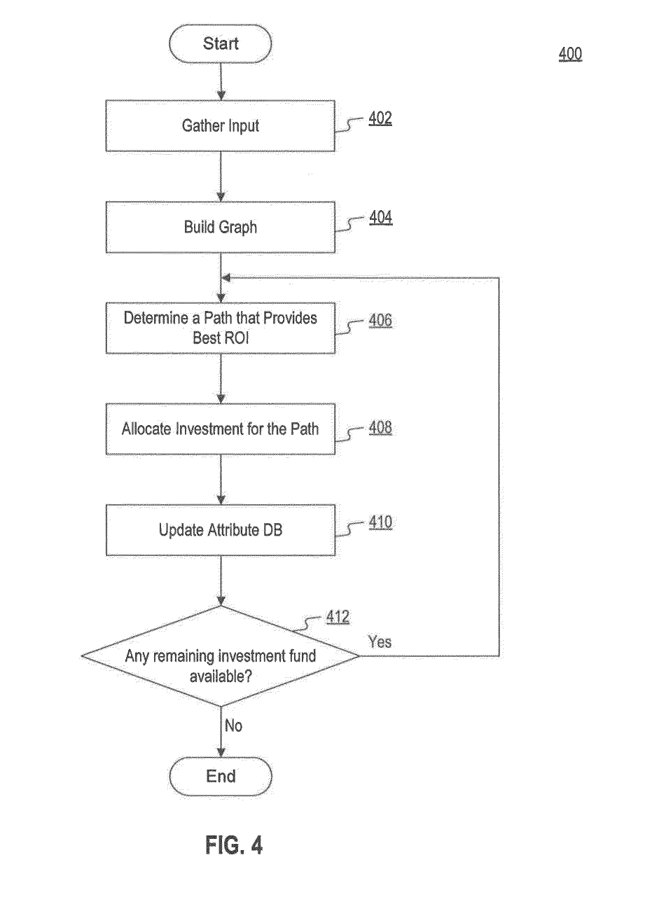

FIG. 4 is a flowchart of an exemplary investment fund allocation process 400, consistent with some embodiments of the present disclosure. The investment fund allocation process 400 may be implemented by a computer system, e.g., fund allocation system 300. At step 402, the investment fund allocation process may gather input associated with an application from a user or an external system. A user may input a navigation tree of the application through user interface or a file entry. For example, the investment fund allocation process may present a graphical user interface in a manner allowing the user to input a directed graph based on navigation tree service by drawing the directed graph. Input may also be gathered from an external system, such as web analytics. Additionally, the user may enter attributes for each node and path of the navigation tree, for example, incremental invest amount and incremental revenue value associated with each nodes and paths of the navigation tree. The investment fund allocation process may also gather attributes of the navigation tree from external systems, such as web analytics. Furthermore, if the graph information entered by the user is invalidated by certain validation rules, the investment fund allocation process may request the user to edit the graph information according to the validation rules.

At step 404, the investment fund allocation process may build a directed graph, e.g., a navigation tree, based on the information gathered from the user or external system. For example, the investment fund allocation process may identify a directed graph based on inputs related to a navigation tree service. In the case of navigation tree service comprising a website or application, the investment fund allocation process may identify a root node corresponding to the homepage of the website, or the main view of the application. The investment fund allocation process may also identify the connection between the webpages, that is, the paths of the directed graph. The investment fund allocation process may display the graph including nodes, edges, paths, and attributes levels, to the user through a display unit.

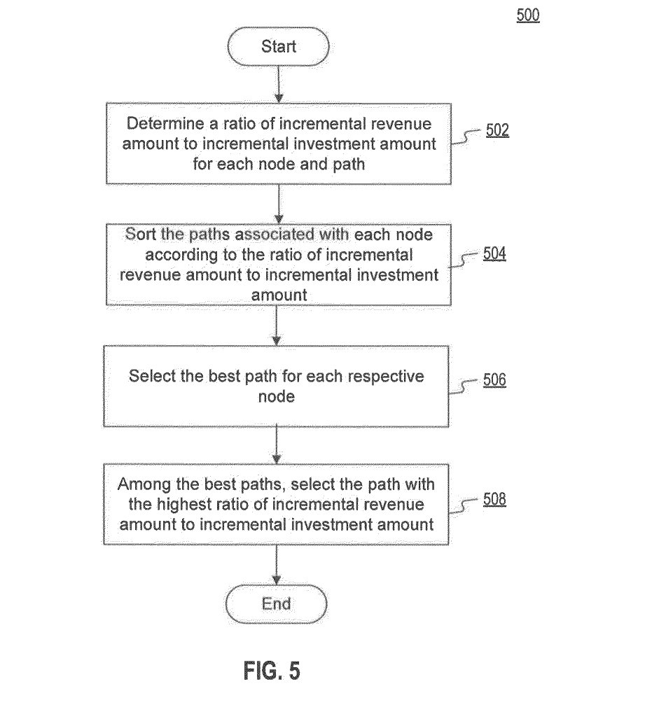

At step 406, the investment fund allocation process may determine a path that provides the best return on investment (ROI). An exemplary method with respect to determining a path that provides the best ROI will be described below in connection with FIG. 5.

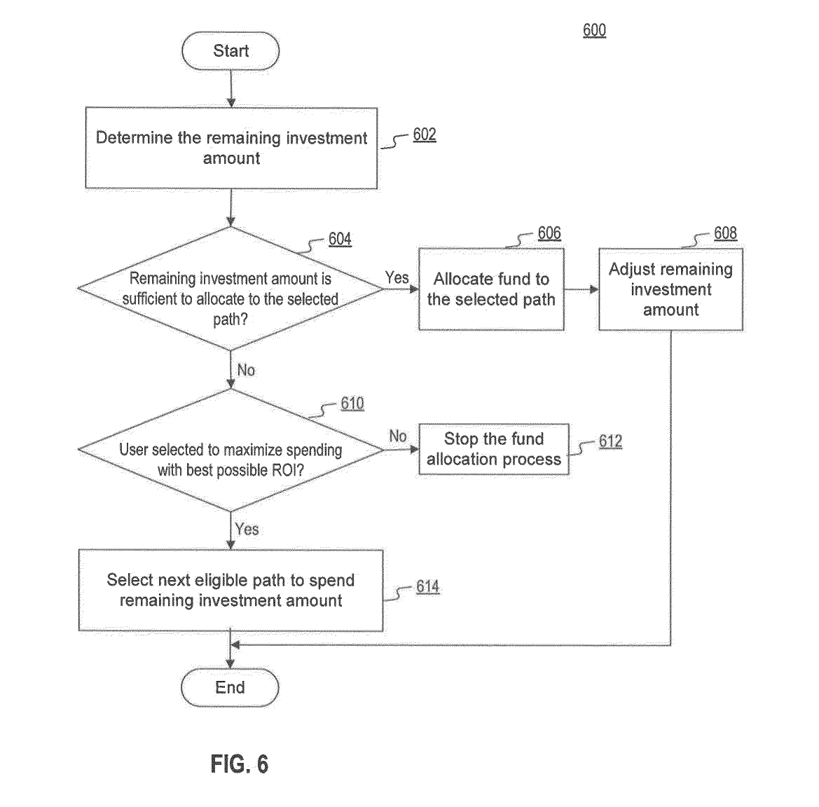

At step 408, the investment fund allocation process may allocate investment for the path. An exemplary method with respect to allocating investment for the path will be described below in connection with FIG. 6.

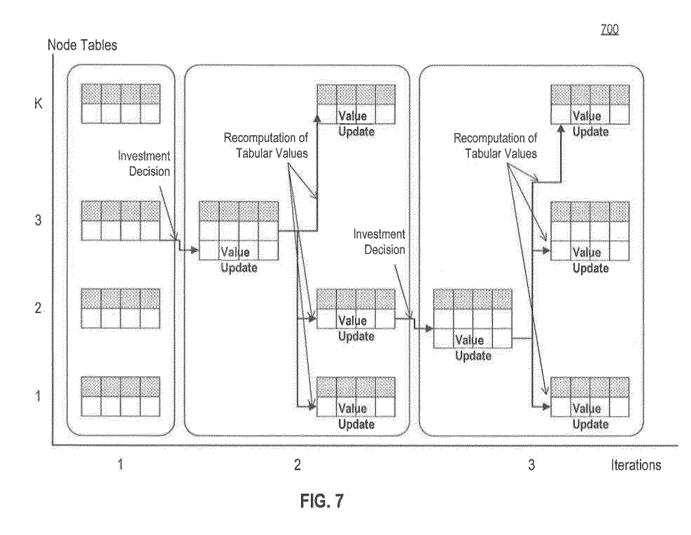

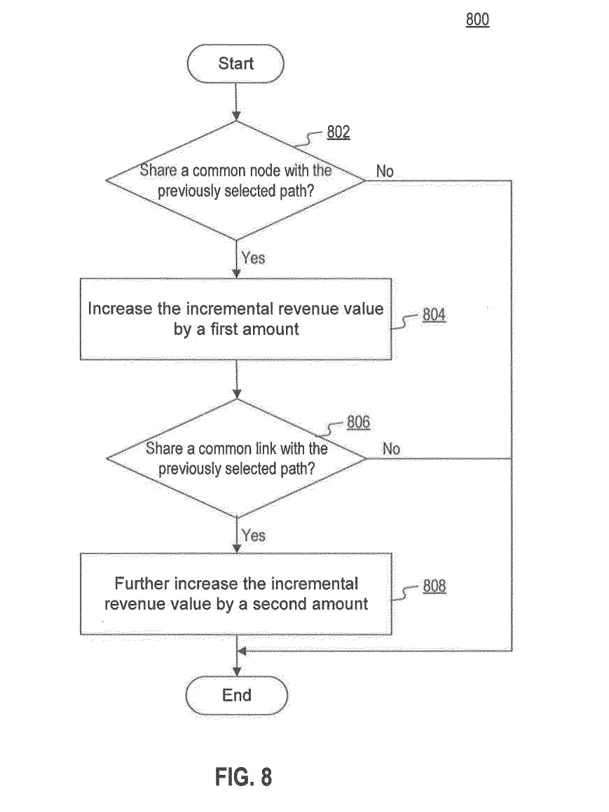

After allocating the fund to the path, the investment fund allocation process may update the attributes database at step 410. An exemplary method with respect to updating the attributes database will be described below in connection with FIGS. 7 and 8.

At step 412, the investment fund allocation process may check whether any remaining investment fund is available. If there are no remaining investment funds available, the investment fund allocation process 400 may terminate. If there are remaining investment funds to be allocated, the investment fund allocation process 400 may return to step 406 and repeat steps 406-412. By iterating through steps 406-412, the investment fund allocation process may progressively compute the best paths for fund allocation until no remaining funds are available.

FIG. 5 is a flowchart of an exemplary method 500 for determining a path for allocating investment funds, consistent with some embodiments of the present disclosure. In the exemplary method 500, a path of the directed graph that provides the best return on investment may be identified for investment fund allocation. The exemplary method 500 may be implemented by a computer system, for example, by investment optimization module 325 of fund allocation system 300.

The method 500 can take account of the attributes associated with each node and path in the directed graph representative of an application. In some implementations, for each node of the graph, a table may be used to represent the attributes associated with the paths connected with the node. An example table is illustrated in table 1. The number of rows in the table may depend on the number of paths associated with the node. For example, the more paths associated with the node, the more rows may be included in the table. The attributes data such as current spent level, current revenue earning, incremental investment amount, incremental revenue value, may be obtained by input from users or input from external systems.

TABLE 1
Example attributes table for a node

| Current | Current Revenue | | Incremental |
|---|---|---|---|
| Spent Level | Earning Level | Incremental Investment | Revenue |
| (Cumulative) | (per unit time) | Amount | Value |
| 150 | 200 | 15 | 45 |
| 100 | 120 | 10 | 20 |

As shown in step 502 of FIG. 5, the method for identifying a path for investment fund allocation may begin by determining a ratio of incremental revenue value to incremental investment amount for each node and path. That is, a ratio of incremental revenue value to incremental investment amount is determined for each row of the attributes table associated with the nodes of the directed graph. For example, in Table 1, the ratio of incremental revenue value to incremental investment amount for the path associated with the first row of the table equals 45 (the incremental revenue) divided by 15 (the incremental investment amount), resulting in a ratio of 3. The ratio of incremental revenue value to incremental investment amount for the path associated with the second row of the table equals 20 (the incremental revenue) divided by 10 (the incremental investment amount), resulting in a ratio of 2.

At step 504, for each node, the paths may be sorted according to the ratio of incremental revenue value to incremental investment amount in a decreasing order. In other words, the rows in the attributes table may be rearranged such that the first row contains the highest ratio of incremental revenue value to incremental investment, the second row contains the second highest ratio of incremental revenue value to incremental investment, and so on. For example, in Table 1, the first row contains the highest ratio of incremental revenue value to incremental investment amount, i.e., a ratio of 3, and the second row contains the second highest ratio of incremental revenue value to incremental investment amount, i.e., a ratio of 2. The sorting process is performed for each of the node in the directed graph. In case that two paths having the same ratio of incremental revenue value to incremental investment amount, the path having a smaller incremental investment amount may be given a preference and placed first in the table.

At step 506, the best path, that is, the path having the highest ratio of incremental revenue value to incremental investment, may be selected for each respective node. The best path corresponds to the first row of the attributes table after the sorting process. For example, in Table 1, the path associated with the first row having the incremental investment amount of 15 and incremental revenue value of 45 may be selected as the best path for this node.

At step 508, among the best paths of all the nodes, the best path of the node which has the highest ratio of incremental revenue value to incremental investment may be selected as the path for investment fund allocation. In case that two best paths having the same ratio of incremental revenue value to incremental investment amount, the path having a smaller incremental investment amount may be selected as the path for investment fund allocation. For example, if two best paths have the same ratio of incremental revenue value to incremental investment amount, while one best path has an incremental investment amount of 15, and the other best path has an incremental investment amount of 10, the path having the incremental investment amount of 10 may be selected as the path for investment fund allocation.

FIG. 6 is a flowchart of an exemplary method 600 for allocating investment funds to a selected path, consistent with some embodiments of the present disclosure. The selected path may be the path identified by the exemplary method 500 described above. The exemplary method 600 may be implemented by a computer system, for example, by investment optimization module 325 of fund allocation system 300.

As shown in step 602 of FIG. 6, the method for allocating investment funds to a selected path may begin by determining the remaining investment amount. At the initial stage of the fund allocation process 400, the remaining investment amount may equal the total available investment fund for the application. As the fund allocation process iterates through steps 406-412, the remaining investment amount may be calculated as the total available investment fund for the application deducted by the amount allocated out to the paths during the prior iterations.

At step 604, method 600 may proceed by checking whether the remaining investment amount is sufficient to allocate to the selected path. If the remaining investment amount is equaling to or greater than the incremental investment amount associated with the selected path, the remaining investment amount may be considered sufficient to allocate to the selected path. On the other hand, if the remaining investment amount is less than the incremental investment amount associated with the selected path, the remaining investment amount may be considered insufficient to allocate to the selected path.

If the remaining investment amount is sufficient to allocate to the selected path, at step 606, an investment amount equaling the incremental investment amount associated with the selected path may be allocated to the selected path. At step 608, the remaining investment amount may be adjusted by deducting the incremental investment amount associated with the selected path from the remaining investment amount. In addition, the selected path may be removed from the path pool for fund allocation such that the selected path may not be considered or selected again for fund allocation in subsequent iterations.

If the remaining investment amount is not sufficient to allocate to the selected path, at step 610, the method may proceed by checking whether the user selected to maximize spending with best possible ROI. Users may provide inputs as to different options for fund allocation via a user interface, e.g., user interface and/or display module 315.

If the user does not select to maximize spending with best possible ROI (for example, the user may select only to maximize ROI), at step 612, the fund allocation process may be terminated. That is, the remaining investment amount may not be allocated to any of the paths of the directed graph, and no further iterations of steps 406-412 need to be conducted.

On the other hand, if the user selects to maximize spending with best possible ROI, the method may proceed by selecting next eligible path to spend the remaining investment amount at step 614. In this scenario, no investment amount may be allocated to the selected path, and the fund allocation process 400 may continue to iterate through steps 406-412 to search for the next eligible path to spend the remaining investment amount.

FIG. 7 illustrates an incremental attributes updating process 700, consistent with some embodiments of the present disclosure. As shown in FIG. 7, there exists a number of nodes (1, 2, . . . , K) in the graph, and each node is associated with an attributes table. For ease of illustration, the attributes tables contain only one or two rows, while it should be understood that more than two rows may be included in the attributes tables. The shaded row of the attributes table contains names of the attributes, similar as those in Table 1.

After each investment decision (e.g., certain amount of investment funds is allocated to a selected path of the directed graph), the attributes tables associated with nodes 1-K may be updated. For example, the incremental revenue values associated with certain related paths may increase as a result of the investment decision to invest a certain amount of funds to the selected path. In some embodiments, the updated attributes table may be provided by the user through a user interface after each investment decision. In some other embodiments, the updated attributes table may be obtained by an automated re-estimation process, which will be described below in connection with FIG. 8. After each investment decision, the selected path may be marked or removed from the set of paths such that it is not considered for the next iteration of the fund allocation process. Accordingly, in the next iteration, the best path may be the immediate next row to the selected path in the sorted attributes table. It should be noted, however, that in the next iteration, the best path may not be the immediate next row to the selected path in the sorted attributes table, as the fields in the attributes table may be updated as a result of the investment decision.

FIG. 8 is a flowchart of an exemplary method 800 for updating attributes data of a particular path, consistent with some embodiments of the present disclosure. The exemplary method 800 may be iterated through all the nodes and paths to provide an updated attribute database after each investment decision (e.g., certain amount of investment funds is allocated to a selected path of the directed graph). The exemplary method 800 may be implemented by a computer system, for example, by investment optimization module 325 of fund allocation system 300.

As shown in step 802 of FIG. 8, the method for updating attributes data may begin by determining whether the particular path shares a common node with the previously selected path that investment funds have been allocated to. If the particular path does not share any common node with the previously selected path, the attributes data associated with the particular path may remain the same. No updating of the attributes data associated with the particular path may be necessary, and the attributes updating process may move on to a next path to determine whether any attributes updating is necessary. For example, with reference to FIG. 2, if investment funds are allocated to path 206, the incremental revenue value associated with path 212 may remain the same, as path 212 does not share any common node with path 206.

If the particular path shares a common node with the previously selected path that investment funds have been allocated to, the incremental revenue value may be increased by a first amount at step 804. The first amount may be determined based on the incremental revenue value associated with the previously selected path. For example, with reference to FIG. 2, if investment funds are allocated to path 206, the incremental revenue value associated with path 208 may be increased by a certain amount, as path 208 shares the same revenue node with path 206. As another example, with reference to FIG. 2, if investment funds are allocated to path 216, the incremental revenue value associated with path 218 may be increased by a certain amount, as path 218 shares the two intermediate nodes with path 216.

At step 806, the method may proceed by determining whether the particular path shares a common link with the previously selected path that investment funds have been allocated to. If the particular path does not share any common link with the previously selected path, the incremental revenue value associated with the particular path may not be further increased. For example, with reference to FIG. 2, if investment funds are allocated to path 206, the incremental revenue value associated with path 208 may not be further increased, as path 208 does not share any common link with path 206.

If the particular path shares a common link with the previously selected path that investment funds have been allocated to, the incremental revenue value may be further increased by a second amount at step 808. The second amount may be determined based on the incremental revenue value associated with the previously selected path. For example, with reference to FIG. 2, if investment funds are allocated to path 214, the incremental revenue value associated with path 212 may be further increased by a second amount, as path 212 shares a common link with path 214. As another example, with reference to FIG. 2, if investment funds are allocated to path 216, the incremental revenue value associated with path 218 may be further increased by a second amount, as path 216 shares a common link with path 218. After updating the attributes data for the particular path, the exemplary method 800 may be applied to the remaining nodes and paths of the graph until all the nodes and paths for possible fund allocation have been checked and/or updated by the method.

The specification has described systems and methods for optimizing investment fund allocation for an application. The illustrated steps are set out to explain the exemplary embodiments shown, and it should be anticipated that ongoing technological development will change the manner in which particular functions are performed. These examples are presented herein for purposes of illustration, and not limitation. For example, steps or processes disclosed herein are not limited to being performed in the order described, but may be performed in any order, and some steps may be omitted, consistent with disclosed embodiments. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for optimizing investment fund allocation for an application, comprising:
identifying a directed graph representative of the application, the directed graph comprising a plurality of nodes and paths, wherein an incremental investment amount and an incremental revenue value are associated with the respective nodes and paths;
determining, using a computer processor, a path of the directed graph that provides a maximum return on investment among the plurality of paths of the directed graph;
allocating an investment amount, equaling the incremental investment amount associated with the path, to the path of the directed graph; and
updating the incremental revenue value associated with the respective nodes and paths based on the incremental revenue value associated with the path of the directed graph.

2. The method of claim 1, further comprising:
repeating the determining, allocating, and updating steps until no investment amount is available.

3. The method of claim 1, wherein determining the path of the directed graph that provides the maximum return on investment is based, at least in part, on a ratio of the incremental revenue value to the incremental investment amount associated with the respective nodes and paths.

4. The method of claim 3, wherein determining the path of the directed graph that provides the maximum return on investment comprises:
sorting, a plurality of paths associated with the respective nodes, according to the ratio of the incremental revenue value to the incremental investment amount for the plurality of paths associated with the respective nodes.

5. The method of claim 4, further comprising:
determining that remaining investment funds are insufficient to allocate to a particular path of the directed graph;
determining that a user selects to maximize spending with best possible return on investment; and
excluding the particular path as the path of the directed graph.

6. The method of claim 1, wherein updating the incremental revenue value associated with the respective nodes and paths comprises:
determining that one or more of the respective nodes and paths share a common node with the path of the directed graph; and
increasing, the incremental revenue value associated with the one or more of the respective nodes and path, by a first amount, based at least in part, on the incremental revenue value associated with the path of the directed graph.

7. The method of claim 6, wherein updating the incremental revenue value associated with the respective nodes and paths further comprises:
determining that the one or more of the respective nodes and paths share a common link with the path of the directed graph; and
increasing, the incremental revenue value associated with the one or more respective nodes and path, by a second amount, based at least in part, on the incremental revenue value associated with the path of the directed graph.

8. The method of claim 1, wherein the application is an e-commerce website.

9. A system for optimizing investment fund allocation for an application, comprising:
one or more hardware processors; and
a memory storing instructions that, when executed by the one or more hardware processors, cause the one or more hardware processors to perform operations including:
identifying a directed graph representative of the application, the directed graph comprising a plurality of nodes and paths, wherein an incremental investment amount and an incremental revenue value are associated with the respective nodes and paths;
determining a path of the directed graph that provides a maximum return on investment among the plurality of paths of the directed graph;
allocating an investment amount, equaling the incremental investment amount associated with the path, to the path of the directed graph; and
updating the incremental revenue value associated with the respective nodes and paths based on the incremental revenue value associated with the path of the directed graph.

10. The system of claim 9, wherein the memory stores instructions that, when executed by the one or more hardware processors, cause the one or more hardware processors to further perform operations including:
repeating the determining, allocating, and updating steps until no investment amount is available.

11. The system of claim 9, wherein determining the path of the directed graph that provides the maximum return on investment is based, at least in part, on a ratio of the incremental revenue value to the incremental investment amount associated with the respective nodes and paths.

12. The system of claim 11, wherein determining the path of the directed graph that provides the maximum return on investment comprises:
sorting, a plurality of paths associated with the respective nodes, according to the ratio of the incremental revenue value to the incremental investment amount for the plurality of paths associated with the respective nodes.

13. The system of claim 12, wherein the memory stores instructions that, when executed by the one or more hardware processors, cause the one or more hardware processors to further perform operations including:
determining that remaining investment funds are insufficient to allocate to a particular path of the directed graph;
determining that a user selects to maximize spending with best possible return on investment; and
excluding the particular path as the path of the directed graph.

14. The system of claim 9, wherein updating the incremental revenue value associated with the respective nodes and paths comprises:
determining that one or more of the respective nodes and paths share a common node with the path of the directed graph; and
increasing, the incremental revenue value associated with the one or more of the respective nodes and path, by a first amount, based at least in part, on the incremental revenue value associated with the path of the directed graph.

15. The system of claim 14, wherein updating the incremental revenue value associated with the respective nodes and paths further comprises:
determining that the one or more of the respective nodes and paths share a common link with the path of the directed graph; and
increasing, the incremental revenue value associated with the one or more respective nodes and path, by a second amount, based at least in part, on the incremental revenue value associated with the path of the directed graph.

16. The system of claim 9, wherein the application is an e-commerce website.

17. A non-transitory computer-readable medium storing instructions for optimizing investment fund allocation for an application that, when executed by a processor, cause the processor to perform operations including:
identifying a directed graph representative of the application, the directed graph comprising a plurality of nodes and paths, wherein an incremental investment amount and an incremental revenue value are associated with the respective nodes and paths;
determining a path of the directed graph that provides a maximum return on investment among the plurality of paths of the directed graph;
allocating an investment amount, equaling the incremental investment amount associated with the path, to the path of the directed graph; and
updating the incremental revenue value associated with the respective nodes and paths based on the incremental revenue value associated with the path of the directed graph.

18. The non-transitory computer-readable medium of claim 17, wherein the non-transitory computer-readable medium stores instructions that, when executed by the processor, cause the processor to further perform operations including:
repeating the determining, allocating, and updating steps until no investment amount is available.

19. The non-transitory computer-readable medium of claim 17, wherein determining the path of the directed graph that provides the maximum return on investment is based, at least in part, on a ratio of the incremental revenue value to the incremental investment amount associated with the respective nodes and paths.

20. The non-transitory computer-readable medium of claim 19, wherein determining the path of the directed graph that provides the maximum return on investment comprises:
sorting, a plurality of paths associated with the respective nodes, according to the ratio of the incremental revenue value to the incremental investment amount for the plurality of paths associated with the respective nodes.

21. The non-transitory computer-readable medium of claim 20, wherein the non-transitory computer-readable medium stores instructions that, when executed by the processor, cause the processor to further perform operations including:
determining that remaining investment funds are insufficient to allocate to a particular path of the directed graph;
determining that a user selects to maximize spending with best possible return on investment; and
excluding the particular path as the path of the directed graph.

22. The non-transitory computer-readable medium of claim 17, wherein updating the incremental revenue value associated with the respective nodes and paths comprises:
determining that one or more of the respective nodes and paths share a common node with the path of the directed graph; and
increasing, the incremental revenue value associated with the one or more of the respective nodes and path, by a first amount, based at least in part, on the incremental revenue value associated with the path of the directed graph.

23. The non-transitory computer-readable medium of claim 22, wherein updating the incremental revenue value associated with the respective nodes and paths further comprises:
determining that the one or more of the respective nodes and paths share a common link with the path of the directed graph; and
increasing, the incremental revenue value associated with the one or more respective nodes and path, by a second amount, based at least in part, on the incremental revenue value associated with the path of the directed graph.

24. The non-transitory computer-readable medium of claim 17, wherein the application is an e-commerce website.
